(19) United States
(12) Patent Application Publication
(10) Pub. No.: US 2007/0263913 A1
(43) Pub. Date: Nov. 15, 2007

(54) MATCHING METHODS AND APPARATUS USING LANDMARK POINTS IN A PRINT

(76) Inventors: SAM M. DANIEL, TEMPE, AZ (US); BEHNAM BAVARIAN, NEWPORT COAST, CA (US); PETER Z. LO, LAKE FOREST, CA (US); HARSHAWARDHAN M. WABGAONKAR, PLACENTIA, CA (US)

Correspondence Address: MOTOROLA, INC., 1303 EAST ALGONQUIN ROAD, IL01/3RD, SCHAUMBURG, IL, 60196, US

(21) Appl. No.: 11/383,449

(22) Filed: May 15, 2006

(51) Int. Cl. G06K 9/00

(52) U.S. Cl. 382/125

(57) ABSTRACT

A method for comparing a search print to a plurality of file prints includes performing a gray scale-based matching process, wherein cross-section profile pairs are determined between minutiae and landmark points in a search print and corresponding respondent prints, and individual similarity measures are computed based on the cross-section profile pairs using an elastic correlation process. A composite similarity measure is computed from the individual similarity measures. Optimizations such as segment outlier optimization (to eliminate outlier segments/minutiae points from the composite similarity measure computation) and adjusting the landmark point location in the search or respondent print can be implemented to maximize the composite similarity measure for a given respondent print. This maximized composite similarity measure can be combined with a similarity measure from another print matcher such as another gray scale-based matcher.

### FIELD OF THE INVENTION

The present invention relates generally to biometrics and more specifically to matching a search print against a plurality of file prints based on gray scale images of the prints and one or more landmark points detected in the images.

### BACKGROUND OF THE INVENTION

Fingerprint-based identification is one of the most important biometric technologies because of its widespread use and its accuracy. Law enforcement organizations use fingerprints to confirm the identity of assumed crime suspects or to determine the identity of unknown suspects from prints left at a crime scene. A fingerprint left at a crime scene is typically referred to as a latent print, and the search process of the latent print against a fingerprint database is commonly known as a latent search. There are, generally, two types of latent searches. One is a latent print to ten-print search. The other is a ten-print to unsolved or unidentified latent search, also known as a reverse search.

Conventional minutiae matching of a latent print (e.g., a search print) against a fingerprint database (e.g., a file print database) is commonly used to narrow that number of candidate file print matches for a given search print. Minutiae matching of fingerprints involves finding a translation and an orientation of the search print's minutiae with respect to a given file print's minutiae, which leads to a match based on a prescribed tolerance of proximity between corresponding minutiae. Exploring a relatively large translation and rotation space is typically involved in the minutiae matching process. Accordingly, when a large file print database is involved, a result may be that an incorrect file print is indicated as a potential match (or respondent file print) to the search print while a true match in the database is missed. This can occur, for example, because the minutiae cluster identified in the search print are located in a geographic region of the search print that is different from a geographic region of the respondent file print in which the mated file print minutiae are located.

Such a situation of disparate geographic regions in the search and respondent file prints is easily perceived by a manual visual examination. However, due to limited resources for manually examining prints and the fact that databases are increasingly growing in size, it would be advantageous to provide for an automated way of generating a geographic similarity measure to assist in determining the probability of whether a respondent file print is a true match to a given search.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a basic block diagram illustrating an exemplary fingerprint matching system implementing a geographic gray scale matcher in accordance with embodiments of the present invention.

FIG. 2 is a flow diagram illustrating a method for comparing a search prints to a plurality of file prints in accordance with an embodiment of the present invention.

FIG. 3 is a flow diagram illustrating an exemplary method for determining matched profile pairs and individual similarity measures in accordance with an embodiment of the present invention.

FIG. 4 is a flow diagram illustrating a method in accordance with another embodiment of the present invention.

FIG. 5 is a flow diagram illustrating a method in accordance with another embodiment of the present invention.

FIG. 6 is a flow diagram illustrating a method in accordance with another embodiment of the present invention.

FIG. 7 illustrates an exemplary technique for optimizing a composite similarity measure in accordance with embodiments of the present invention.

FIG. 8 illustrates another exemplary technique for optimizing a composite similarity measure in accordance with embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for print matching based on gray scale images and landmark points in the prints. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for print matching based on gray scale images and landmark points in the prints described herein. If implemented at least in part as software the steps of the method can be added as one or more modules to existing software. As such, these functions may be interpreted as steps of a method to perform the print matching based on gray scale images and landmark points in the prints described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language. Moreover, an embodiment of the present invention can be implemented as a computer-readable storage element having computer readable code stored thereon for programming a computer to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a print matcher (referred to as a geographic gray scale matcher or “geoGSM”) compares a search (e.g., latent) print to a plurality of respondent file prints based on the gray scale images of the prints and using at least one landmark point (e.g., core or delta) and mated minutiae points in the search and respondent file prints. More specifically, the geoGSM obtains a gray scale image of the search print, a search print landmark point and a plurality of predetermined search print minutiae points located in a first geographic region of the search print and obtains, for each file print in a set of selected file prints, a file print gray scale image, a file print landmark point and a plurality of file print minutiae points that are mated to at least a portion of the plurality of predetermined search print minutiae points. The file print landmark point and the file print mated minutiae points are located in a second geographic region of the selected file print.

For each file print in the set of selected (e.g., respondent) file prints, geoGSM determines, for at least a portion of the file print minutiae points, a matched profile pair comprising a first cross-section profile between the file print minutia point and the file print landmark point and a second cross-section profile between the corresponding search print mated minutiae and the search print landmark point, and an individual similarity measure that is indicative of the similarity between the first and second cross-section profiles, wherein the individual similarity measures may be computed using an elastic correlation process. GeoGSM further computes (for each file print in the set of selected file prints) a composite similarity measure based on the individual similarity measures, which is an aggregate of the elastic correlation of the corresponding matched profile pairs. The composite similarity measure is indicative of similarity between the first geographic region in the search print and the second geographic region in the file print, wherein the aggregate elastic correlation is used as a discriminant substantially precluding chance mating of search minutiae points in wrong regions of the respondent file prints.

In accordance with the teachings herein, optimizations with respect to, for instance, relative geographic location and quality of minutiae points, quality of cross-section profiles and adjustments in the location of a landmark point on either the search or file print can be used to iteratively perform the matching process in order to maximize the computed composite similarity measure. The composite similarity measure for the respondent file prints may be combined with another similarity measure output from one or more other print matchers, such as a minutiae matcher and/or another gray scale-based matcher. Using the teachings herein, some non-matching respondent prints previously scoring higher than the actual matching print are demoted in a final rank order based on the combined scores. Those skilled in the art will realize that the above recognized advantages and other advantages described herein are merely exemplary and are not meant to be a complete rendering of all of the advantages of the various embodiments of the present invention.

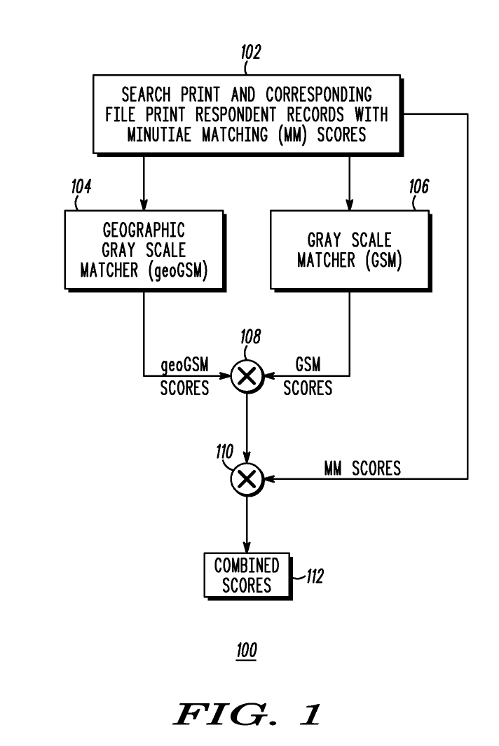

Referring now to the drawings, and in particular FIG. 1, a block diagram of an exemplary fingerprint matching system implementing embodiments of the present invention is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print, such toe and palm prints. As such, other alternative implementations of using different types of prints are contemplated and are within the scope of the various teachings described.

System 100 is generally known in the art as an Automatic Fingerprint Identification System or (AFIS) as it is configured to automatically (typically using a combination of hardware and software) compare a given search print record (for example a record that includes an unidentified latent print) to a database of file print records (e.g., that contain ten-print records of known persons) and identifies one or more candidate file print records that match the search print record. The ideal goal of the matching process is to identify, with a predetermined amount of certainty and without a manual visual comparison, the unknown search print as having come from a person who has prints stored in the database. At a minimum, AFIS system designers and manufactures desire to significantly limit the time spent in a manual comparison of the search print to candidate file prints (also referred to herein as respondent file prints).

Before describing system 100 in detail, it will be useful to define terms that are used herein. A print is a pattern of ridges and valleys on the surface of a finger (fingerprint), toe (toe print) or palm (palm print), for example. A minutiae point is a small detail in the print pattern and refers to the various ways that ridges can be discontinuous. Examples of minutiae are a ridge termination or ridge ending where a ridge suddenly comes to an end and a ridge bifurcation where a ridge divides into two ridges. A landmark point is a point or feature in a print that serves as a geographic landmark or marker for comparing geographic regions of two prints having mated minutiae. Landmark points can include, for example, core and delta points of a print or a designated point. In general, a designated landmark point is one whose connecting segments to the mated minutiae cluster are well within a region of fair to good image quality and radials from it are maximally orthogonal to the minutiae tails angles.

A geographic region is defined by a predetermined area on a print and may be identified by an area of pixel locations. A similarity measure is any measure (also referred to herein interchangeable with the term score) that identifies or indicates similarity of a file print to a search print based on one or more given parameters. A gray scale image is a data matrix that uses values, such as pixel values at corresponding pixel locations in the matrix, to represent intensities of gray within some range.

Turning again to the description of the AFIS 100 illustrated in FIG. 1. The AFIS 100 includes a functional portion or block 102, a geoGSM 104 in accordance with the teachings herein, another gray scale-based matcher (GSM) 106, combination logic 108 and 110, and an indication of final scores 112. Functional portion 102 comprises all of the hardware and software needed to supply geoGSM 104 and GSM 106 with inputs to enable these matchers to perform their portions of the overall fingerprint matching process.

At a minimum, the output (and corresponding input into the geoGSM 104) includes a search print landmark point and a plurality predetermined search print minutiae points located in a given geographic region of the search print, a set of respondent file prints with corresponding file print landmark points and plurality of identified minutiae points that are mated to at least a portion of the plurality of predetermined search print minutiae points, wherein the set of mated minutiae points for a file print are located in a given geographic region of the file print. Block 102 also provides a manner of identifying the search and file prints (e.g., using an identification or ID associated with a given fingerprint) that geoGSM 104 uses in its comparison process and may also provide to geoGSM 104 gray scale images of the search print and file prints in the set of selected respondent file prints or alternatively and depending on the computational limitations of the AFIS 100 at least some pre-computed and stored cross-section profiles that geoGSM uses to compute its composite similarity measures for a set of selected respondent file prints in accordance with the teachings herein. Block 102 provides to the GSM 106 at least the search and file print gray scale images (or associated pre-computed cross-section profiles), search and respondent file print IDs, search print minutiae and corresponding mated file print minutiae typically (but not necessarily) for the same set of selected respondent file prints as provided to geoGSM.

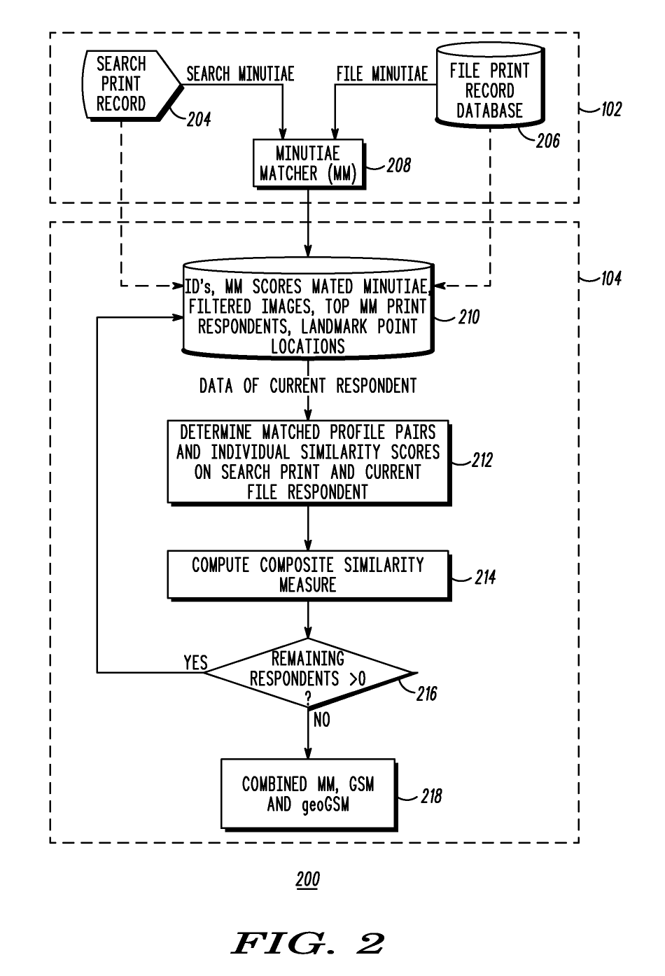

Turning momentarily to FIG. 2, block 102 accordingly comprises at a minimum an active search print record 204, a file print database 206 and a minutiae matcher (MM) 208. The search print record includes a print image such as a gray scale image that is optionally band-limited using a band-pass filter including, but not limited to, 2-dimensional uniform, raised-cosine, Gaussian filters and the like. The search print in this particular exemplary implementation is generated from a latent search print lifted from a crime scene and scanned into the AFIS 100. The search record further comprises a plurality of minutiae points and at least one landmark point identified in the active search print using any conventional process including manual identification by a human examiner. Skilled artisans will realize that, in an alternative implementation, the active search print record may comprise a known ten-print and corresponding gray scale images for comparing against a latent print database, for example in a reverse search performed by geoGSM 104.

The file print record database stores a plurality of file print records that each comprise one or more print images (e.g., gray scale images and/or band-limited versions thereof) corresponding to one or more fingers (e.g., a known ten-print) and for each finger a plurality of identified minutiae points. At least a portion or a subset of the file print records has one or more identified landmark points. In one embodiment, database 206 is maintained by a law enforcement agency and is usually located remote to the AFIS 100 and accessed using a suitable database management system as is well known in the art and is, therefore, not described in detail here for the sake of brevity.

MM 208 is any suitable minutiae matching system that performs a topological comparison between the locations of the identified minutiae points for the search print and the locations of the identified minutiae points from fingerprints in file print records in database 206. This process generally yields a set of mated minutiae for a portion of the file prints in the database, with a subset of search minutiae being associated with a corresponding matching subset of file print minutiae. Using these mated minutiae, MM quantifies the degree of match between the search print and the file prints in terms of numerical scores, sorts them accordingly, and returns a match report that includes the top-ranked respondent file print IDs with their individual scores.

Turning back FIG. 1, other than those elements described above, block 102 may further comprise hardware, software, firmware or any combination thereof for implementing other known AFIS elements including, but not limited to, a controller to, for instance, distribute information to the various matchers and an input and enrollment station to capture prints (using cameras, scanners, etc) and to extract relevant matching features, e.g., minutiae points, landmark points, cores, deltas, loops, whorls, and the like, from the prints for use in later comparison processes.

GSM 106 uses the data from block 102, namely the gray scale images or representations thereof (e.g., pre-computed cross-section profiles), to compare the active search print usually against the top MM file print respondents provided by the MM 208. Complementing MM's topological matching of search and file print minutiae, GSM 106 focuses on similarity measures based on the gray scale ridge structure within and in the immediate neighborhood of the convex hull defined by the mated minutiae clusters on the search print and the top-ranked MM file print respondents and generates a corresponding GSM metric that indicates such similarity between the search and file prints. In general, for a given file print and for each possible combination of minutiae pair (from the set of mated minutiae) on the search print and corresponding file print, GSM 106 generates a search print segment based on the pair of minutiae from the search print and a file print segment based on the pair of minutiae from the file print; generates a search print cross-section profile based on the search print segment and a file print cross-section profile based on the file print segment; and correlates one of the profiles against the other profile to compute an individual similarity measure (e.g., based on a correlation coefficient) that is indicative of the similarity between the search print cross-section profile and the file print cross-section profile. GSM combines the individual correlation coefficients to generate a GSM metric for a given file print respondent.

The GSM metrics produced by GSM for the top MM respondents may then be “fused” or combined with the corresponding geoGSM scores and MM scores using operators 108 and 110, which may comprise additive, multiplicative, eigenspace or other suitable methods alone or in combination, to generate fused or combined scores 112. The top-ranked MM respondent file prints are then re-ranked according to the fused scores. An example of a GSM that can be used to implement GSM 106 is described in US Publication No. 2004/0258284 A1, titled Gray Scale Matcher, and commonly owned with this application by Motorola, Inc™.

GeoGSM uses a similar process as GSM to output corresponding metrics for the top MM file print respondents. However, a difference is that instead of generating segment and corresponding cross-section pairs based on minutiae pairs in the search and file prints, geoGSM generates segment and corresponding cross-section profiles based on a minutiae and landmark point pair as described below in additional detail. Returning to the flow diagram illustrated FIG. 2, stages 210-218 describe at a high level a process performed by geoGSM to generate its respondent scores. The first geoGSM stage, stage 210, serves as a storage and/or conduit for relevant data pertaining to a selected set of top-ranked MM respondents and can be implemented using any suitable memory element. It includes the respondent file print IDs with their MM scores, their mated minutiae, their landmark point locations and their various gray scale images (or filtered/enhanced versions thereof as described above) and/or pre-computed cross-section profiles as described more fully below. The following detailed description of embodiments of geoGSM 104 with respect to FIGS. 2-8 assumes that each evaluated print (including both the search and respondent prints) has a single landmark point. However, this implementation is without loss of generality. In a typical real world implementation some prints will not have detected landmark points and some may have multiple landmark points.

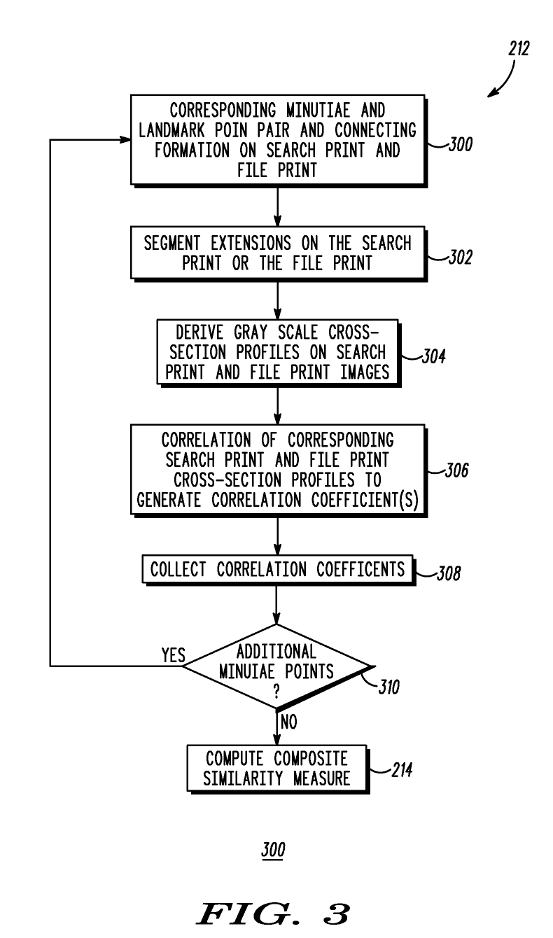

Returning to FIG. 2, at stage 212, for the first selected respondent data is retrieved from stage 210 and a matched cross-section profile pair and corresponding individual similarity measure is generated for each mated minutiae pair on the search and respondent prints. A cross-section profile pair comprises a file print cross-section profile generated based on a file print minutiae point and the file print landmark point and a corresponding search print cross-section profile based on the search print mated minutiae point and the search print landmark point. At stage 214, a composite similarity measure is computed using the individual similarity measures. Stages 212 and 214 are described in additional detail with respect to FIGS. 3-8.

At stage 216, it is determined whether each respondent has been processed by geoGSM. If not, the process repeats with data for the next respondent obtained from stage 210. If all respondents have been processed, their corresponding combined similarity measures can be fused as described above, for example, to generate combined or fused MM, GSM and geoGSM scores at stage 218. As processing of each file print is completed at step 214, the composite similarity measure is stored (optionally along with the corresponding mated minutiae used to generate the composite measure) until all MM respondents have been processed. At this point, the scores can optionally be normalized to unity, as is appropriate for latent matching. However, this policy may not be desirable in other applications where raw metrics would be more meaningful to one skilled in the art.

Turning now to FIG. 3, a flow diagram illustrating a method for determining matched profile pairs and individual similarity measures (step 212 of FIG. 2) is shown and generally indicated. Steps 300-310 that follow comprise a loop that processes the selected MM respondents, one file print at a time. Step 300 acquires a first minutia (at an associated pixel location or coordinate) and landmark point (also at an associated pixel location) from the file print and generates a file print line segment and acquires a first mated minutiae and mated landmark point from the search print and forms a search print line segment. With the minutiae and landmark points taken as endpoints of an ideal straight line segment, sampled segments may be constructed by inserting intermediate pixel coordinates that fall closest to these lines. As a consequence, corresponding, or matched sampled segments on the search and file prints (also referred to herein as a matched segment pair) may be defined by respective lists of the intermediate points that have been inserted in the ideal search and file print segments.

Step 302 operates on matched segment pairs, one at a time, using extension and oversampling techniques as is well known in the art. Using these techniques, either the search or file print segment can be extended if needed such that one segment of the matched segment pair is longer than the other segment.

Step 304 accepts the matched segment pair, one of which has been extended as needed and uses the search and file print images stored in stage 210 (FIG. 2) to derive the corresponding matched cross-section profiles. In general, geoGSM uses the matched segment pair to sample the search and file print images at their respective coordinate points (the minutiae and landmark points and intermediate points comprising the matched segment pair) and returns corresponding lists of gray scale values that comprise search and file print image sampled cross-section profiles (or waveforms) referred to herein as matched profile pairs. As stated above, the images may be the original gray scale ones or band-limited versions thereof.

Step 306 takes the final matched profile pair and correlates the shorter profile against the longer profile, computing correlation coefficients at each shift position from left to right, for instance, in search of a maximum measure of similarity, which can be stored at step 308 as the individual geoGSM similarity measure or score for the file print being analyzed. Skilled artisans will realize that geoGSM can further accommodate for both maximum positive and maximum negative correlation techniques by computing a maximum conventional correlation coefficient and a maximum absolute correlation coefficient, transforming or normalizing these coefficients, and storing them at step 308 as the individual similarity measures associated with that file print. Step 310 determines whether all of the relevant mated minutiae points have been processed for the file print and if not steps 300-308 are repeated until there are none remaining to process, wherein a composite similarity measure or score is computed at step 214 (FIG. 2) using the individual similarity measures stored at step 308 using techniques well known in the art.

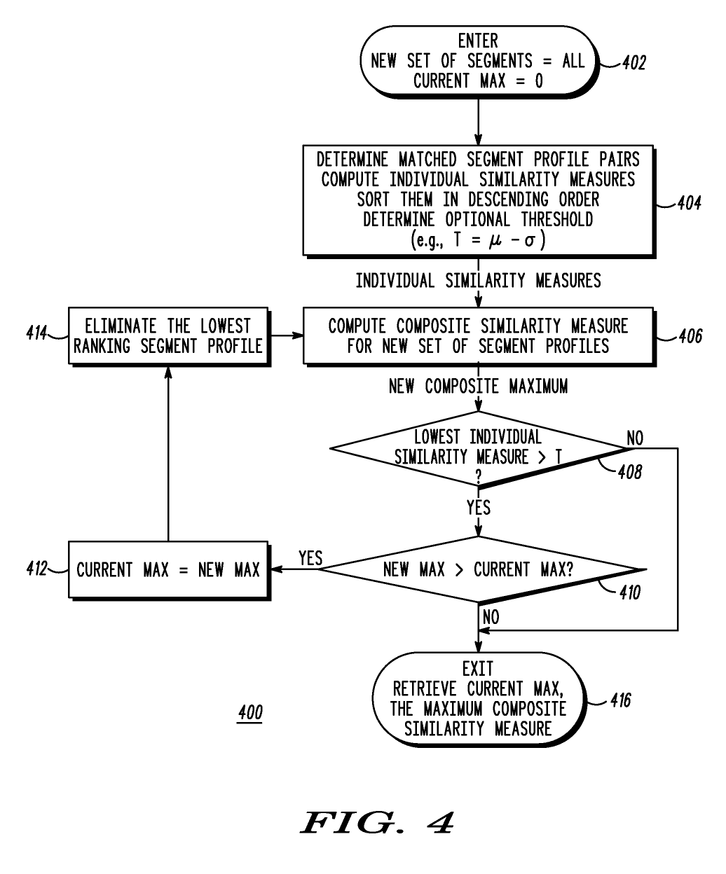

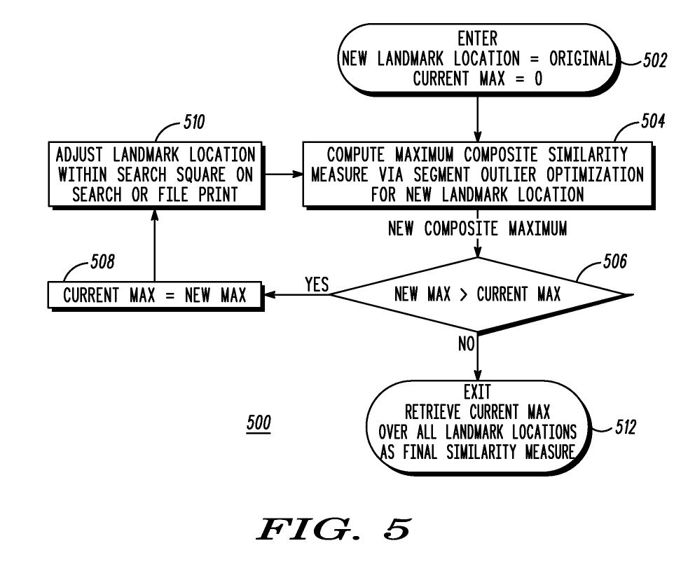

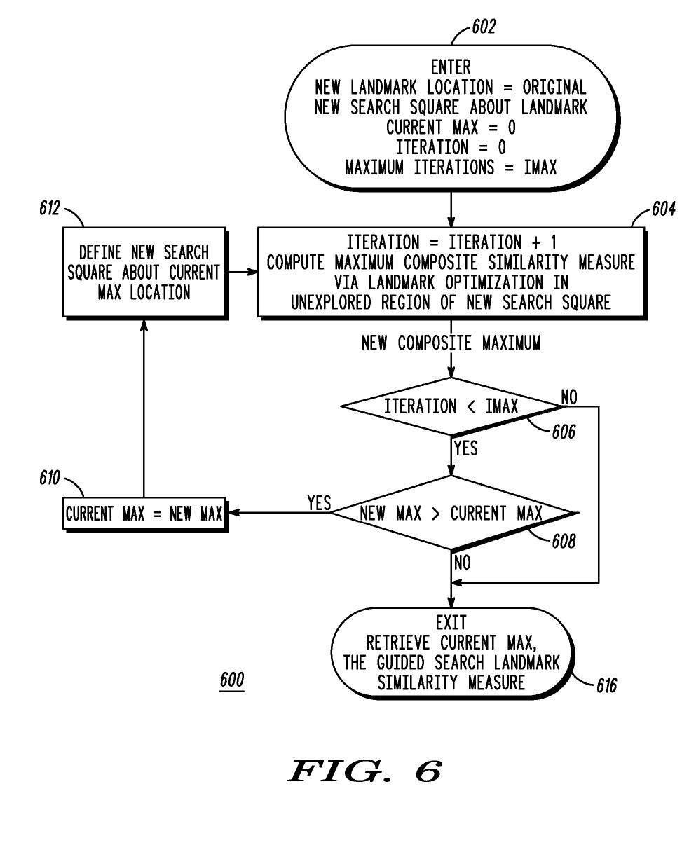

Turning now to FIG. 4, a flow diagram illustrating a method in accordance with another embodiment of the present invention is shown and generally indicated at 400. Given that there is usually a difference in quality between fingerprint images based on many factors, it is expected that some of the segments (and corresponding cross-section profiles) based on the search and respondent prints will be of lower quality than other segments. The optimization process of method 400 accommodates for these differences in quality by weighting down those lower quality segments to reach a more optimal maximum composite score. This so-called “segment outlier optimization process” may be combined with other optimization techniques including the so-called “landmark location optimization process” and the “guided search landmark optimization process” as described in detail below by reference to FIG. 5 and FIG. 6, respectively.

At step 402, geoGSM initiates method 400 with the segment pairs generated at step 300 (FIG. 3) for the current respondent and a current maximum similarity measure (Current Max), which is initialized to zero. At step 404, geoGSM determines the matched segment profile pairs and the corresponding individual similarity measures (e.g., the maximum individual correlation coefficient(s)) associated with all of the segment pairs for that respondent. These coefficients are downward sorted from highest to lowest and, optionally, compared to a predetermined threshold to determine which of the segment pairs are systematically eliminated from the composite score computation to optimize the composite score. An exemplary threshold (T) that can be used to determine the “outliers” or excluded segment pairs is (T=μ-σ), where μ represents the mean of the complete set of individual similarity measures, and σ represents the standard deviation of the complete set of individual similarity measures. Use of a threshold is not strictly necessary but serves as a guard against excessive elimination of “outliers”, thereby, making the results of the segment outlier optimization process more reliable.

Using the current set of individual similarity measures, geoGSM computes a composite similarity measure, at step 406. At step 408, geoGSM compares the current lowest individual similarity measure from the downward sorted list to the threshold, if its value is greater than the threshold the process retains the Current Max in memory and ends at step 416, wherein Current Max can be retrieved as the maximum composite similarity measure for the respondent. Otherwise, the composite similarity measure based on the current set of segment pairs (e.g., New Max) is compared to Current Max at step 410. If New Max is less than or equal to Current Max (basically when the composite similarity measure either stops increasing or starts to decrease), again the process retains the Current Max and ends at step 416. Otherwise Current Max is set to equal New Max at step 412. GeoGSM eliminates the lowest ranking cross-section profile pair (associated with the lowest individual similarity score), at step 414, and repeats the loop with this new set of cross-section profile pairs by computing the composite similarity measure based on this revised set of cross-section profile pairs. It should be noted that by storing only the maximum running composite similarity measure at each iteration of the optimization process, a savings in storage space is realized by not storing all computed maximum composite scores at each stage.

Of importance to note is that the above-described segment outlier optimization process is not limited to the geoGSM matcher 104. Other gray scale-based matchers such as the GSM matcher 106 can implement this optimization process to maximize their composite respondent scores. The outlier segments may be different for each matcher using this process, therefore, an alternative embodiment may include a cross-feed back between the matchers using the segment outlier optimization process for sharing outlier information to further maximize the composite similarity measures output from the respective matchers.

Just as it is expected that some segments may be of lower quality than other segments on a given print, it is also expected that error may accompany the detection of landmark points. If the accuracy of a given landmark point is questionable, its pixel location may be improved by using the landmark location optimization process 500 in accordance with a further embodiment of the present invention, as illustrated in FIG. 5. This process evaluates the composite similarity measure for a respondent over a predefined grid in a relatively small neighborhood (or search region) about the original pixel location of the landmark point. This optimization process is designed to augment the location of landmark points in such a way as to maximize the composite similarity measure for a given respondent.

For purposes of method 500, a landmark point on either the search print or the file print is taken as accurate and the adjustments performed with respect to the other print. For example, where the search print is a latent print whose landmark point was manually detected by a human examiner, geoGSM may take the search print landmark point as accurate, thereby, holding its location constant and adjust the mated landmark point on the respondent print. However, in certain situations, it may be more advantageous to instead adjust the landmark point on the search print such as when the landmark point on the search print is automatically detected. Once it is determined which landmark point is to be adjusted, the question then becomes how the adjustments are made and to what extent (e.g., a stopping criterion).

Using the current technology for automatically detecting landmark points in file prints, it has been determined that it is not unusual to see errors in such detection ranging up to and occasionally exceeding 16 pixels. Accordingly, it is not unreasonable to assume that, with a high probability, a given file print's landmark point is actually located somewhere within a 24×24 pixel square (or grid) centered around the original location at which the landmark point was detected. Therefore, in one embodiment geoGSM adjusts the respondent landmark point location to at least a portion of the 49 pixel locations in the 24×24 pixel grid and retains only the maximum composite score computed at any one of those points.

Accordingly, process 500 is initialized at step 502 with the landmark location being set to the original location, and a current running maximum composite score (Current Max) is initialized to zero. At step 504, geoGSM computes the maximum composite similarity score using the segment outlier optimization process of FIG. 4, for the current landmark point location. If at step 506, the maximum composite similarity score computed based on the current landmark point location (e.g., New Max) is greater than Current Max, then: Current Max is set to New Max at step 508; the landmark point is adjusted to a next location on the grid at step 510; and steps 504-508 are repeated until all of the desired points on the grid have been visited. At stage 512, Current Max is the maximum and final composite similarity measure over all of the landmark point locations. In one implementation, each of the 49 pixel locations on the 24×24 pixel grid is visited. However, in other embodiments only some of the pixel locations are visited, such as every four pixel locations, depending for example on image resolution of the print images. Moreover, it should be realized that a 24×24 pixel grid size is merely exemplary and a smaller or larger grid can be used without loss of generality.

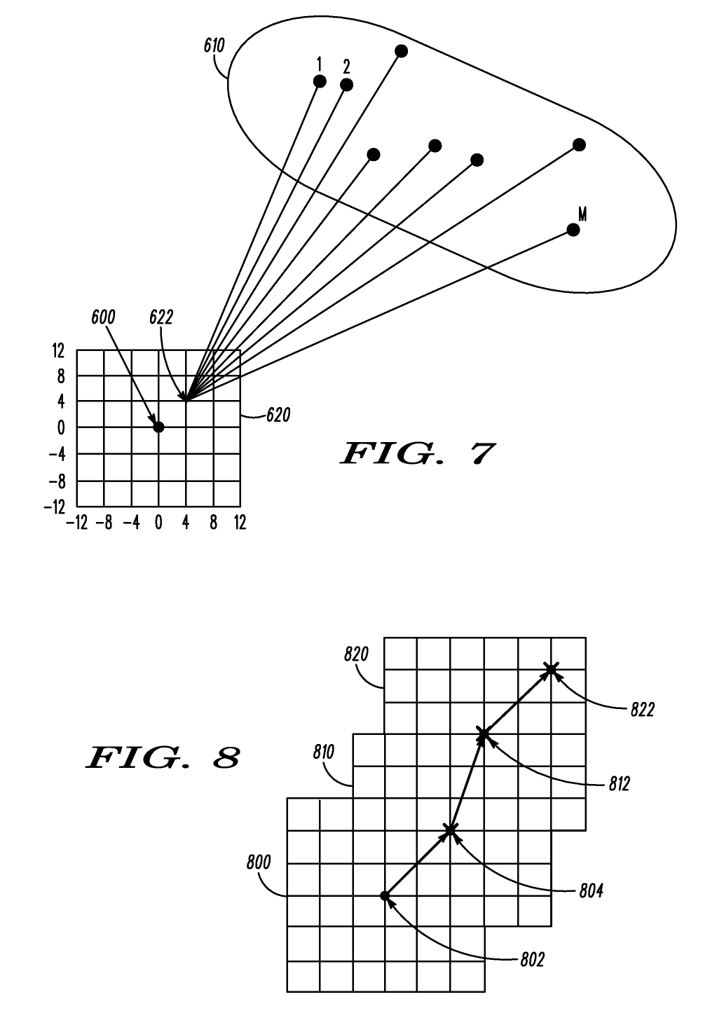

FIG. 7 illustrates a 24×24 pixel grid 720. At the center of grid 720 is located a point 700 that represents the original detected location of the respondent landmark point. A first iteration of method 500 is performed based on the landmark point location 700 beginning with an entire set of mated file print minutiae 710 comprising minutiae enumerated from 1 to M. Thereafter, at step 510, the landmark point is adjusted to a position (n) 722 and steps 504-508 are again performed with respect to the minutiae points 710. Recall that when geoGSM performs segment outlier optimization, it usually eliminates some segment pairs from the composite similarity measure computation. It should be noted that, upon adjusting the landmark point location at step 510 the outliers may be different because the corresponding cross-section profiles for the file print mated minutiae are now different. Therefore, step 502 is initiated with all of the file print mated minutiae prior to beginning segment the outlier optimization process at each new landmark point pixel location.

Sometimes the correct location of the landmark point may be outside of the 24×24 pixel region (which can be indicated for example by a maximum computed composite score lying close to the edge of the grid). In that case, use of grid 720 will improve the composite similarity measure for a respondent print, but the composite score may nonetheless remain far from optimal. To accommodate for this case, geoGSM may be configured to extend the landmark optimization process outside of grid 720 using the guided search landmark optimization process. FIG. 6 and FIG. 8 are used to illustrate this extended landmark point optimization process.

Accordingly, upon determining a landmark location (e.g. a pixel location 804) corresponding to the maximum composite similarity measure for the initial grid (800) and an initial landmark location (e.g., a pixel location 802), geoGSM initiates process 600 by setting a revised “original” landmark point to pixel location 804, centers a new 24×24 pixel search square 810 around location 804; initializes a New Max variable to zero, initializes an Iteration variable to zero, and initializes a Maximum Iterations value equal to a predefined value of Imax, representing for example a maximum of eight iterations. The Iteration variable keeps a running total of times the landmark location optimization process 500 is performed during method 600, and the Maximum Iterations value is the maximum number of times the landmark location optimization process can be performed during method 600.

At step 604, the Iterations variable is increased by one, and a corresponding maximum similarity composite measure is computed using the landmark location optimization process 500 at those selected pixel locations of grid 810 that do not overlap pixel locations of grid 800, and New Max is set to equal this score (which in FIG. 8 corresponds to a pixel location 812). GeoGSM determines at step 606 whether the Iteration variable has reached Imax and if so the process stops at step 616, and Current Max can be retrieved as the optimized or overall composite similarity measure for the respondent.

If the Iteration variable is less than Imax, geoGSM proceeds at step 608 to compare New Max to Current Max (which at Iteration=1 is the maximum composite score computed at pixel location 804). If New Max is the same as or equal to Current max, then the process ends at step 616. Otherwise, if New Max is greater than Current Max, then Current Max is set equal to New Max at a step 610, a sew search square (e.g., 820) is defined around the pixel location (e.g., 812) corresponding to Current Max, and GeoGSM continues to search for the maximum composite score (e.g. corresponding to pixel location 822) until some stopping criterion is reached. In one embodiment, the stopping criterion can be that the maximum composite at each pixel location corresponds to the same or a lower score than the Current Max score. However, other stopping criterion may be used. For example, as indicated above, the process may terminate when the number of iterations for performing the landmark location optimization process in method 600 exceeds a maximum value, e.g., Imax.

As stated above, some search and respondent prints may have multiple mated landmark points. For example, many prints may include up to two cores and two deltas. Accordingly, geoGSM can be further configured to accommodate this situation. In this case, for each respondent/search print pair having multiple landmark points, the processes illustrated in FIGS. 3-6 are performed for each landmark point, and a corresponding maximum composite similarity measure computed. The multiple maximum composite similarity measures can then be combined.

For example, geoGSM can compute the overall maximum composite similarity measure for the respondent print as the geometric mean of the individual maximum composite similarity measures corresponding to the multiple landmark points. The geometric mean is used as a way of guarding against the inadvertent demotion of the matching print in case it is missing a landmark point that a contending non-matching respondent print might possess. Other measures such as Root Mean Square value of the individual composite similarity measures, the maximum of all the maximum scores, etc., could alternatively be employed. Optionally, geoGSM could further determine a common excluded subset of mated minutiae between the multiple landmark points. This special subset includes only those mated minutiae common to all of the subsets corresponding to multiple landmark points and could be used in further AFIS processing.

In the above embodiments, geoGSM determined relevant cross-section profiles directly from the gray scale-images. However, storage and/or computational restraints, for example, in an AFIS may preclude such direct computations. In this instance, at least a portion of the cross-section profiles needed to compute the individual similarity measures and the corresponding composite similarity measures can be pre-computed and stored to be retrieved and used as needed, thereby, improving retrieval efficiency. In addition, these cross-section profiles may be coded for instance with 4, 2 and 1 bit of quantization, the latter involving a binarized image. Using run-length encoding, these quantities may be stored more compactly.

The efficiency and accuracy of the geoGSM process may be further improved by excluding minutiae in close proximity to the landmark in question as determined by a predefined proximity threshold or some other selection criterion. Also low quality minutiae and profiles, as well as profiles associated with segments, the substantial portions of which cross ridges at shallow angles, can be excluded from the composite similarity measure based on respective thresholds and/or selection criteria as is well known in the art. Those of ordinary skill in the art will realize that the segment outlier optimization process may, however, edit out some of these instances. It should be further realized by skilled artisans that these additional optimization and efficiency techniques can be extended to the GSM 106 without loss of generality.

In a final embodiment of geoGSM discussed here, the matcher can be used as a filter. Here, geoGSM can be used as a measure of plausibility that the mated minutiae on the search and each of the respondent file prints is indeed situated in a geographically similar location, thereby, filtering the respondent prints before sending them on to the GSM process and to the more detailed geoGSM process described above by reference to FIGS. 2-8. For each respondent file print, a geographic region defined by a pixel region around the search landmark point and the minutiae points can be defined and compared to a geographic region around the respondent landmark point and minutiae points to determine an initial geographic similarity measure. This initial measure is compared to a threshold. For example, if there are at least 2 landmark points that are matched between two prints, a baseline formed by them can serve as a reference (e.g., the threshold) for relative geographic location of the mated minutiae. The respondent prints having an associated initial geographic similarity measure that is less than this threshold are not further processed by geoGSM and GSM.

In the foregoing specification, certain embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in non-limiting embodiments the term is defined to be within 10%, 5%, 1% or 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for comparing a search print to a plurality of file prints, the method comprising the steps of:
obtaining a search print landmark point and a plurality of predetermined search print minutiae points located in a first geographic region of a search print;
obtaining, for each file print in a set of selected file prints, a file print landmark point and a plurality of file print minutiae points that are mated to at least a portion of the plurality of predetermined search print minutiae points, the file print landmark point and the file print mated minutiae points being located in a second geographic region of the selected file print; and
for each file print in the set of selected file prints,
determining, for at least a portion of the file print minutiae points, a matched profile pair comprising a first cross-section profile between the file print minutia point and the file print landmark point and a second cross-section profile between the corresponding search print mated minutiae and the search print landmark point, and an individual similarity measure that is indicative of the similarity between the first and second cross-section profiles; and
computing a composite similarity measure based on the individual similarity measures, the composite similarity measure being indicative of similarity between the first geographic region in the search print and the second geographic region in the file print.

2. The method of claim 1 further comprising the steps of;
for each matched profile pair corresponding to a file print in the set of selected file prints,
comparing the individual similarity measures to a threshold; and
determining a maximum composite similarity measure by eliminating from the composite similarity measure computation at least a portion of the individual similarity measures that fall below the threshold.

3. The method of claim 2, wherein each composite similarity measure is combined with at least one other similarity measure for the corresponding file print to generate a combined similarity measure, wherein the at least one other similarity measure is computed based on a gray scale image of the search print and corresponding gray-scale images of the file prints in the set of selected file prints.

4. The method of claim 3, wherein the at least one other similarity measure that is computed based on a gray scale image of the search print and corresponding gray-scale images of the file prints in the set of selected file prints is computed using a method comprising the steps of, for each selected file print:
for each possible combination of mated minutiae pairs in the first and second subsets,
selecting a first pair of minutiae points from the plurality of predetermined search print minutiae points and a second pair of corresponding mated minutiae points from the file print minutiae points,
generating a first segment based on the first pair of minutiae points and a second segment based on the second pair of minutiae points,
generating a third cross-section profile based on the first segment and a fourth cross-section profile based on the second segment,
computing a second individual similarity measure that is indicative of the similarity between the third cross-section profile and the fourth cross-section profile, and
comparing the second individual similarity measure to a second threshold; and
computing a second composite similarity measure based on the second individual similarity measures associated with the third and fourth cross-section profiles, wherein a second maximum similarity measure, which is the at least one other similarity measure, is computed by eliminating from the second composite similarity measure computation at least a portion of the second individual similarity measures that fall below the second threshold.

5. The method of claim 1, wherein the search print and the file prints in the set of selected file prints are stored as gray scale images, and determining each of the cross-section profiles comprises the steps of:
determining a pixel location pair corresponding to the landmark point and the minutiae point;
sampling the gray scale image at a plurality of pixel locations between the pixel location pair to generate a plurality of sampled pixel locations;
obtaining a plurality of gray scale values corresponding to the plurality of sampled pixel locations; and
generating the cross-section profile based on the plurality of gray scale values.

6. The method of claim 1 further comprising the steps of:
for each file print in the set of selected file prints,
adjusting one of the search print landmark point and the file print landmark point location;
determining corresponding individual similarity measures based on the adjusted landmark point location; and
computing the corresponding composite similarity measure based on the adjusted landmark point location.

7. The method of claim 6 further comprising the step of computing a maximum composite similarity measure by iteratively adjusting the landmark point location, computing the corresponding composite similarity measure and maintaining the maximum composite similarity measure until a stopping criterion is reached.

8. The method of claim 7, wherein the stopping criterion is associated with a predetermined search region around the landmark point that is being adjusted.

9. The method of claim 1, wherein the landmark points are each one of a core, a delta and a designated landmark point.

10. The method of claim 1 further comprising the steps of:
receiving an initial set of file prints, each file print in the initial set comprising a file print landmark point and a plurality of file print minutiae points mated to at least a portion of the plurality of predetermined search print minutiae points; and
for each file print in the initial set of file prints,
comparing the first geographic region of the search print to the second geographic region of the file print using the file and search print landmarks points and the plurality of file print minutiae points and corresponding mated search print minutiae points to generate an initial geographic region similarity measure;
comparing the initial geographic region similarity measure to a threshold; and
generating the set of selected file prints by excluding from the initial set of file prints those file prints associated with an initial geographic similarity measure that is less than the threshold.

11. The method of claim 1, wherein the search print and the set of selected file prints comprise one of fingerprints, palm prints and toe prints.

12. The method of claim 1 further comprising the steps of:
for each file print in the set of selected file prints,
comparing each of the plurality of file print minutia points to a selection criterion; and
excluding from the composite similarity measure computation those file print minutiae points that do not meet the selection criterion.

13. Apparatus for comparing a search print to a plurality of file prints, the apparatus comprising:
a memory element storing a search print landmark point and a plurality of predetermined search print minutiae points located in a first geographic region of a search print, and further storing, for each file print in a set of selected file prints, a file print landmark point and a plurality of file print minutiae points that are mated to at least a portion of the plurality of predetermined search print minutiae points, the file print landmark point and the file print mated minutiae points being located in a second geographic region of the selected file print; and
a processing device configured for performing the following steps for each file print in the set of selected file prints,
determining, for at least a portion of the file print minutiae points, a matched profile pair comprising a first cross-section profile between the file print minutia point and the file print landmark point and a second cross-section profile between the corresponding search print mated minutiae and the search print landmark point, and an individual similarity measure that is indicative of the similarity between the first and second cross-section profiles; and
computing a composite similarity measure based on the individual similarity measures, the composite similarity measure being indicative of similarity between the first geographic region in the search print and the second geographic region in the file print.

14. The apparatus of claim 13, wherein the memory element further storing the search print and the file prints in the set of selected file prints as gray scale images, and the processing device determining each of the cross-section profiles comprises the processing device performing the steps of:
determining a pixel location pair corresponding to the landmark point and the minutiae point;
sampling the gray scale image at a plurality of pixel locations between the pixel location pair to generate a plurality of sampled pixel locations;
obtaining a plurality of gray scale values corresponding to the plurality of sampled pixel locations; and
generating the cross-section profile based on the plurality of gray scale values.

15. The apparatus of claim 13, wherein the memory element further storing pre-computed and compressed cross-section profiles, and the processing device determining the cross-section profiles comprises retrieving at least a portion of the cross-section profiles from the memory element.

16. The apparatus of claim 15, wherein the cross-section profiles are coded with a pre-determined number of bits of quantization and processed using run-length encoding to generate the compressed cross-section profiles.

17. The apparatus of claim 13, wherein the apparatus comprises at least one of a microprocessor executing code, an Application Specific Integrated Circuit (ASIC), a field programmable gate array (FPGA) and a state machine.

18. A computer-readable storage element having computer readable code stored thereon for programming a computer to perform a method for comparing a search print to a plurality of file prints, the method comprising the steps of:
obtaining a search print landmark point and a plurality of predetermined search print minutiae points located in a first geographic region of a search print;
obtaining, for each file print in a set of selected file prints, a file print landmark point and a plurality of file print minutiae points that are mated to at least a portion of the plurality of predetermined search print minutiae points, the file print landmark point and the file print mated minutiae points being located in a second geographic region of the selected file print; and
for each file print in the set of selected file prints,
determining, for at least a portion of the file print minutiae points, a matched profile pair comprising a first cross-section profile between the file print minutia point and the file print landmark point and a second cross-section profile between the corresponding search print mated minutiae and the search print landmark point, and an individual similarity measure that is indicative of the similarity between the first and second cross-section profiles; and
computing a composite similarity measure based on the individual similarity measures, the composite similarity measure being indicative of similarity between the first geographic region in the search print and the second geographic region in the file print.

19. The computer-readable storage medium of claim 18, wherein the computer readable storage medium comprises at least one of a hard disk, a CD-ROM, an optical storage device and a magnetic storage device.

20. The computer readable storage medium of claim 18, wherein the search print and the file prints in the set of selected file prints are stored as gray scale images, and programming the computer for determining each of the cross-section profiles comprises programming the computer to perform the steps of:
determining a pixel location pair corresponding to the landmark point and the minutiae point;
sampling the gray scale image at a plurality of pixel locations between the pixel location pair to generate a plurality of sampled pixel locations;
obtaining a plurality of gray scale values corresponding to the plurality of sampled pixel locations; and
generating the cross-section profile based on the plurality of gray scale values.
